(19) United States
(12) Patent Application Publication
(10) Pub. No.: US 2024/0162571 A1
(43) Pub. Date: May 16, 2024

(54) BATTERY PACK FOR A VEHICLE

(71) Applicants: HYUNDAI MOTOR COMPANY, Seoul (KR); KIA CORPORATION, Seoul (KR)

(72) Inventors: Yu Ri Oh, Hwaseong-si (KR); In Gook Son, Incheon (KR); Seok Eun Yoon, Seoul (KR)

(73) Assignees: HYUNDAI MOTOR COMPANY, Seoul (KR); KIA CORPORATION, Seoul (KR)

(21) Appl. No.: 18/198,427

(22) Filed: May 17, 2023

(30) Foreign Application Priority Data
Nov. 10, 2022 (KR) 10-2022-0149843

(51) Int. Cl. H01M 50/507; B60K 1/04; H01M 50/204; H01M 50/509

(52) U.S. Cl. CPC H01M 50/507; B60K 1/04; H01M 50/204; H01M 50/509; B60K 2001/0438; H01M 2220/20

(57) ABSTRACT

A battery pack for a vehicle includes: a base member forming a skeleton, a bus bar mounted on the base member, a connection groove formed by being depressed in the base member, a wire inserted into the connection groove, and a member cover coupled to the base member to block the bus bar and the connection groove from the outside.

### CROSS REFERENCE TO RELATED APPLICATION

The present application claims priority to and the benefit of Korean Patent Application No. 10-2022-0149843, filed on Nov. 10, 2022, the entire contents of which are incorporated herein by reference.

### BACKGROUND

### Field of the Disclosure

The present disclosure relates to a structure of a battery pack for a vehicle.

### Description of the Related Art

Recent electric or hybrid vehicles are equipped with a battery pack to supply power required for driving a motor of a vehicle.

The battery pack has a plurality of battery modules mounted therein, and each battery module includes a plurality of battery cells.

The battery pack accommodates the battery modules in a battery case to protect the battery modules from external impact or inflow of moisture.

The battery case may include: a lower case surrounding a lower side and a side surface of the battery modules, and an upper case coupled to an upper side of the lower case to block a space in which the battery modules are disposed from the outside.

The battery case includes reinforcing members disposed between a plurality of battery modules accommodated therein to ensure rigidity of the battery case itself and to form a solid fixed state of the battery module. The reinforcing members may include a longitudinal member elongated in a front-rear direction of a vehicle and a transverse member elongated in a transverse direction of a vehicle.

The matters described in this BACKGROUND section are provided only to enhance understanding of the background of the present disclosure and should not be taken as acknowledging that the matters constitute prior art already known to those having ordinary skill in the art.

### SUMMARY OF THE DISCLOSURE

An object of the present disclosure is to provide a battery pack for a vehicle that optimizes a structure of a reinforcing member provided inside a battery pack to improve rigidity of a battery case, aims to compact components for electrical connection and communication connection inside the battery pack. The battery pack effectively protects components for electrical connection and communication connection from flames when thermal runaway phenomenon occurs inside the battery pack, and effectively suppresses propagation of flames.

In one embodiment of the present disclosure, a battery pack for a vehicle includes: a base member forming a skeleton, a bus bar mounted on the base member, a connection groove formed by being depressed in the base member, and a wire inserted into the connection groove. The battery pack further includes: a member cover coupled to the bus bar and blocking the connection groove from the outside, and a reinforcing member assembly configured to include the base member, the bus bar, the connection groove, the wire, and the member cover.

The connection groove may be formed in an upper portion of a cross-section of the base member, wherein the cross-section is perpendicular to a length direction of the base member, and the connection groove may extend along the length direction of the base member.

The bus bar may be mounted on at least one of both sides of the cross-section perpendicular to the length direction of the base member in the base member.

The bus bar mounting groove into which the bus bar is inserted may be formed long along the length direction of the base member.

With the bus bar inserted into the bus bar mounting groove, when a surface of the base member and a surface of the bus bar are aligned and the member cover is coupled to the base member, an inner surface of the member cover may be configured to come into planar contact with a surface of the base member and the bus bar.

A plurality of bus bars may be symmetrically mounted on both sides of the cross-section perpendicular to the length direction of the base member.

The bus bar mounting groove of the base member may be formed in the lower side than the connection groove in such a manner so as to be vertically spaced away from the connection groove.

A cross-section of perpendicular to the length direction of the base member may be formed of a square cross-section.

The member cover may have a cross-sectional structure surrounding both sides and an upper side of a square cross-section of the base member.

The wire inserted into the connection groove is a wire for communication.

A cross-section of the base member perpendicular to the length direction of the base member may be formed of a square cross-section, the member cover may be formed in a shape surrounding both sides and an upper side of a square cross-section of the base member, and the bus bar may be inserted and mounted in the bus bar mounting groove formed on both surfaces of the square cross-section of the base member.

The plurality of bus bar mounting grooves may be vertically disposed on both surfaces of the square cross-section of the base member.

The connection groove may be formed in a central portion of an upper side of the square cross-section of the base member, and bank portions of both sides of the connection groove may be in close contact with an inside of both corners of the member cover.

The reinforcing member assembly may be elongated in a longitudinal direction of a vehicle in which the battery pack is mounted.

The reinforcing member assembly may be elongated along a transverse direction of the vehicle in which the battery pack is mounted.

In addition, a reinforcing member assembly for a battery case of a vehicle of the present disclosure for achieving the above object is configured to include a base member forming a skeleton; a bus bar mounting groove formed by being depressed on a surface of the base member to mount a bus bar; a connection groove formed by being depressed on the surface of the base member; and a member cover coupled to the base member to block the bus bar mounting groove and the connection groove from the outside.

A cross-section of the base member perpendicular to a length direction of the base member may be formed of a square cross-section, the member cover may be formed in a shape surrounding both sides and an upper side of a square cross-section of the base member, the bus bar mounting groove may be formed on both surfaces of the square cross-section of the base member, and the connection groove may be formed on an upper surface of the square cross-section of the base member.

The bus bar mounting groove of the base member may be formed in the lower side than the connection groove in such a manner so as to be vertically spaced away from the connection groove.

The connection groove may be formed in a central portion of an upper side of the square cross-section of the base member, and bank portions of both sides of the connection groove may be in close contact with an inside of both corners of the member cover.

With the bus bar mounting groove inserted into the bus bar, when the surface of the base member and the surface of the bus bar are aligned and the member cover is coupled to the base member, the inner surface of the member cover may be formed to have a depth so as to be in planar contact with a surface of the base member and the bus bar.

The present disclosure optimizes a structure of a reinforcing member provided in a battery pack to ensure rigidity of a battery case, aims to compact components for electrical connection and communication connection inside the battery pack, effectively protects components for electrical connection and communication connection from flames when thermal runaway phenomenon occurs inside the battery pack, and effectively suppresses propagation of flames.

### BRIEF DESCRIPTION OF THE DRAWINGS

FIG. 1 is a view illustrating mounting a battery pack to which the present disclosure is applied to a vehicle.

FIG. 2 is a view illustrating a lower case and a battery module constituting a battery pack according to one embodiment of the present disclosure.

FIG. 3 is a view illustrating a cross-sectional structure of a reinforcing member assembly for a battery case illustrated in FIG. 2.

FIG. 4 is an exploded state view of the reinforcing member assembly illustrated in FIG. 3.

### DETAILED DESCRIPTION

Hereinafter, embodiments disclosed in the present specification are described in detail with reference to the accompanying drawings. However, regardless of the reference character, the same or similar constituent elements shall be given the same reference numerals and the redundant descriptions thereof shall be omitted.

The suffix “module” and “unit” for the constituent elements used in the description below are given or mixed only in consideration of the ease of writing the specification, and do not have any distinctive meaning or role in itself each other.

In describing the embodiments of the present specification, when a specific description of the related art is deemed to obscure the subject matter of the embodiments of the present specification, the detailed description has been omitted. Furthermore, the accompanying drawings are intended to facilitate the understanding of the embodiments set forth in the present specification, and the technical idea of the present specification is not limited by the accompanying drawings. All alterations, equivalents, and substitutes that are included within the technical idea of the present disclosure should be understood as falling within the scope of the present disclosure.

The ordinal number terms first, second, and so on may be used to describe various constituent elements but should not limit these constituent elements. These terms are only used to distinguish one constituent element from another element.

It should be understood that a constituent element, when referred to as being “connected to” or “coupled to” another constituent element, may be directly connected or directly coupled to the another constituent element or may be coupled or connected to the another constituent element with a third constituent element disposed therebetween. In contrast, it should be understood that a constituent element, when referred to as being “directly coupled to” or “directly connected to” another constituent element, is coupled or connected to the another constituent element without a third constituent element therebetween.

A noun in singular form has the same meaning as nouns when used in plural form, unless it has a different meaning in context. When a component, device, element, or the like of the present disclosure is described as having a purpose or performing an operation, function, or the like, the component, device, or element should be considered herein as being “configured to” meet that purpose or to perform that operation or function.

It should be understood that, throughout the present specification, the term “include,” “have,” or the like is intended to indicate that a feature, a number, a step, an operation, a constituent element, a component, or a combination thereof is present, without precluding the possibility that one or more other features, numbers, steps, operations, constituent elements, components, or combinations thereof are present or added.

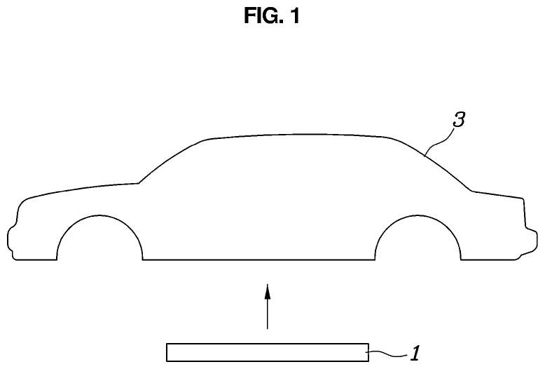

FIG. 1 illustrates mounting of a battery pack 1 to which the present disclosure may be applied to a vehicle. As illustrated in FIG. 1, the battery pack 1 is mounted on a lower side of a floor of a vehicle body 3.

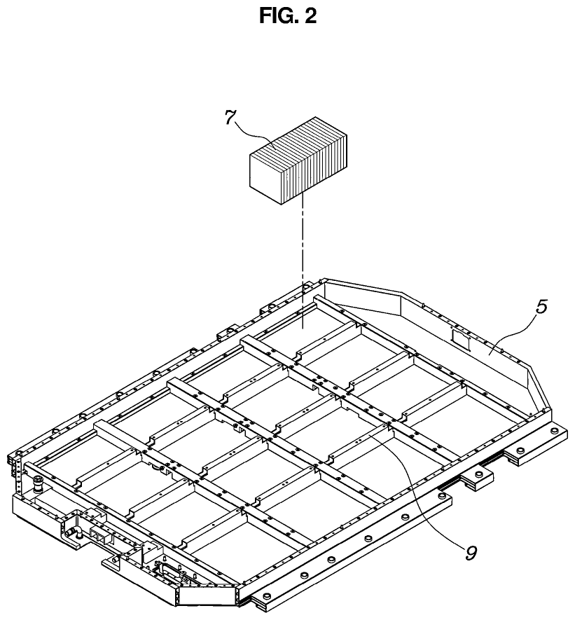

FIG. 2 illustrates a lower case 5 and a battery module 7 constituting the battery pack 1 according to an embodiment of the present disclosure.

In one form, the battery pack 1 includes a battery case, the battery module 7, and the battery module 7 and other devices are accommodated in the battery case. In one form, the battery case includes the lower case 5 and an upper case (not illustrated).

In particular, the lower case 5 accommodate a plurality of battery modules 7, and an upper side of the lower case 5 is covered by the upper case such that the battery modules 7 and other devices accommodated therein are protected from external impact. The upper and lower cases prevent foreign materials or moisture from penetrating into the inside of the cases.

As illustrated in FIG. 2, a reinforcing member assembly 9 of the present disclosure is mounted on the lower case 5.

Referring to FIGS. 1 to 4, in an embodiment of the present disclosure, the battery pack 1 for a vehicle is provided with the reinforcing member assembly 9. The reinforcing member assembly 9 includes a base member 11 forming a skeleton, a bus bar 13 mounted on the base member 11, a connection groove 15 formed by being depressed in the base member 11, a wire 17 inserted into the connection groove 15, and a member cover 19 coupled to the base member 11 to block the bus bar 13 and the connection groove 15 from the outside.

The reinforcing member assembly 9 allows the base member 11 to perform a reinforcing function of the battery case which was in charge of the conventional reinforcing member. In addition, the reinforcing member assembly 9 is configured to be integrated by the member cover 19 in a state including the wire 17 is inserted into the bus bar 13 and the connection groove 15.

The wire 17 may be mainly a wire for communication in the related art, the wire or the bus bar or the like are disposed around or above the battery module 7, and thus when an internal space of the battery case is complicated and thermal runaway phenomenon occurs, the bus bar or the wire is exposed as it is, thereby causing a problem of damage by heat.

However, the reinforcing member assembly 9 according to the present disclosure has a configuration in which the bus bar 13 and the wire 17 are embedded in the member cover 19 so that components for electrical connection and communication connection inside the battery pack 1 are compacted, and when the thermal runaway phenomenon occurs inside the battery pack 1, components for electrical connection and communication connection may be effectively protected from flames.

In addition, as mentioned above, a structure consisting of the base member 11 and the member cover 19 blocks between the battery modules 7 disposed in the lower case 5 more effectively than in the related art, and thus when the thermal runaway phenomenon occurs, an effect of suppressing flames propagation between the battery modules 7 occurs.

In one form, the base member 11 may be formed of a metal material that may provide sufficient rigidity, and the member cover 19 may be formed of a material with strong heat resistance.

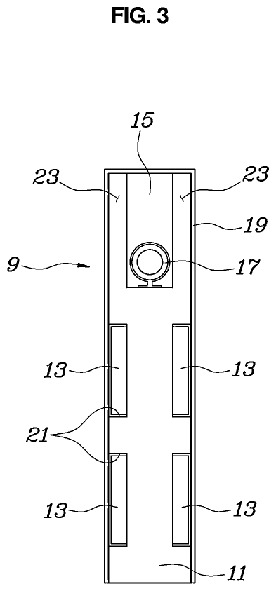

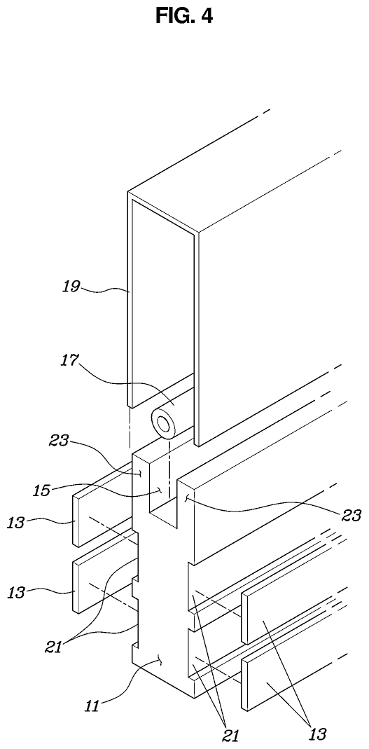

In an embodiment, FIGS. 3 and 4 show a cross-section of the base member 11 as seen in a cross-section perpendicular to a length direction of the base member 11. As illustrated, the connection groove 15 is formed in an upper portion of the cross-section of the base member 11, and the connection groove 15 extends along the length direction of the base member 11.

Accordingly, the wire for communication inserted into the connection groove 15 is disposed long along the length direction of the base member 11 and connects a transmission device and a reception device.

As illustrated in FIG. 4, the bus bar 13 is mounted on at least one of both sides of the base member 11 along the length direction of the base member 11.

A bus bar mounting groove 21, into which the bus bar 13 is inserted, is formed along the length direction of the base member 11, and the bus bar 13 is mounted by inserting into the bus bar mounting groove 21.

In addition, with the bus bar 13 inserted into the bus bar mounting groove 21, when a surface of the base member 11 and a surface of the bus bar 13 are aligned and the member cover 19 is coupled to the base member 11, an inner surface of the member cover 19 is configured to be into planar contact with surfaces of the base member 11 and the bus bar 13, thus, it is desirable to allow a compact configuration to be achieved.

In the embodiment of FIG. 3, a plurality of the bus bars 13 are symmetrically mounted on both sides of the cross-section perpendicular to the length direction of the base member 11.

In addition, the bus bar mounting groove 21 of the base member 11 is formed below the connection groove 15 in such a manner so as to be vertically spaced away from the connection groove 15.

Accordingly, the bus bar mounting groove 21 and the connection groove 15 are adjacent to each other, thereby preventing rigidity of the base member 11 from being weakened, and since the bus bar mounting groove 21 formed at the lower side of the base member 11 has a relatively shallow depth, the lower side of the base member 11 may provide rigidity mainly required by the battery case.

In one embodiment, the cross-section perpendicular to the length direction of the base member 11 is formed by a square cross-section. In other words, the base member 11 has a cross-section that is square-shaped and perpendicular to its length direction.

In addition, the member cover 19 has a cross-sectional structure surrounding an upper side and both sides of a square cross-section of the base member 11.

Accordingly, when the member cover 19 is coupled with the base member 11 in a state where the bus bar 13 and the wire are mounted on the base member 11, a bar having a compact square cross-sectional shape may be formed.

A plurality of the bus bar mounting grooves 21 may be vertically disposed on both surfaces of a square cross-section of the base member 11.

Accordingly, the lower side of the base member 11 does not have a depth too deep to be depressed by the bus bar mounting groove 21, and thus rigidity required by the battery case may be sufficiently provided.

The connection groove 15 is formed in a central portion of an upper side of the square cross-section of the base member 11, and bank portions 23 of both sides of the connection groove 15 are in close contact with an inside of both corners of the member cover 19.

Accordingly, both corners of the member cover 19 are firmly supported by the bank portion 23 of the base member 11, and the wire accommodated in the connection groove 15 may be effectively protected against heat or impact from the outside.

As illustrated in FIG. 2, the reinforcing member assembly 9 may be elongated in a longitudinal direction of a vehicle in which the battery pack 1 is mounted.

In addition, the reinforcing member assembly 9 may be elongated along a transverse direction of the vehicle in which the battery pack 1 is mounted.

In another embodiment, a reinforcing member assembly 9 for a battery case of a vehicle includes: the base member 11 forming the skeleton; the bus bar mounting groove 21 formed by being depressed on the surface of the base member 11 to mount the bus bar 13; the connection groove 15 formed by being depressed on the surface of the base member 11; the member cover 19 coupled to the base member 11 to block the bus bar mounting groove 21 and the connection groove 15 from the outside.

A cross-section of the base member 11 perpendicular to the length direction of the base member 11 is formed by the square cross-section. The member cover 19 is formed in a shape surrounding both sides and an upper side of a square cross-section of the base member 11, and the bus bar mounting groove 21 is formed on both surfaces of the square cross-section of the base member 11. The connection groove 15 may be formed on an upper surface of the square cross-section of the base member 11.

The bus bar mounting groove 21 of the base member 11 is disposed at a position lower than the connection groove 15 so as to be vertically spaced away from the connection groove 15.

The connection groove 15 is formed in a central portion of an upper side of the square cross-section of the base member 11, and bank portions 23 of both sides of the connection groove 15 are in close contact with an inside of both corners of the member cover 19.

In addition, with the bus bar mounting groove 21 inserted into the bus bar 13, when the surface of the base member 11 and the surface of the bus bar 13 are aligned and the member cover 19 is coupled to the base member 11, the inner surface of the member cover 19 is formed to have a depth so as to be in planar contact with the surfaces of the base member 11 and the bus bar 13.

Although the specific embodiments of the present disclosure have been shown and described, it should be apparent to those having ordinary skill in the art that the present disclosure may be variously improved and changed without departing from the technical spirit of the present disclosure.

What is claimed is:

1. A battery pack for a vehicle, comprising:
a base member forming a skeleton;
at least one bus bar mounted on the base member;
a connection groove formed by being depressed in the base member;
a wire inserted into the connection groove;
a member cover coupled to the base member and blocking the at least one bus bar and the connection groove from an outside; and
a reinforcing member assembly configured to include the base member, the at least one bus bar, the connection groove, the wire, and the member cover.

2. The battery pack of claim 1, wherein the connection groove is formed in an upper portion of a cross-section of the base member, which is perpendicular to a length direction of the base member,
wherein the connection groove extends along the length direction of the base member.

3. The battery pack of claim 2, wherein the at least one bus bar is mounted on at least one of sides of the base member.

4. The battery pack of claim 3, wherein a bus bar mounting groove, into which the at least one bus bar is inserted, is formed along the length direction of the base member.

5. The battery pack of claim 4, wherein, with the at least one bus bar inserted into the bus bar mounting groove, when a surface of the base member and a surface of the at least one bus bar are aligned and the member cover is coupled to the base member, an inner surface of the member cover is configured to come into planar contact with a surface of the base member and the at least one bus bar.

6. The battery pack of claim 4, wherein the at least one bus bar includes a plurality of the bus bars symmetrically mounted on sides of the base member.

7. The battery pack of claim 4, wherein the bus bar mounting groove of the base member is disposed lower than the connection groove so as to be vertically spaced away from the connection groove.

8. The battery pack of claim 4, wherein the cross-section perpendicular to the length direction of the base member is formed by a square cross-section.

9. The battery pack of claim 8, wherein the member cover has a cross-sectional structure surrounding an upper side and sides of the square cross-section of the base member.

10. The battery pack of claim 1, wherein the wire inserted into the connection groove is a wire for communication.

11. The battery pack of claim 1, wherein a cross-section of the base member perpendicular to a length direction of the base member is formed by a square cross-section,
wherein the member cover is formed in a shape surrounding both sides and an upper side of the square cross-section of the base member,
wherein the at least one bus bar is inserted and mounted in at least one bus bar mounting groove formed on surfaces of the square cross-section of the base member.

12. The battery pack of claim 11, wherein the at least one bus bar mounting groove includes a plurality of bus bar mounting grooves vertically disposed on surfaces of the square cross-section of the base member.

13. The battery pack of claim 11, wherein the connection groove is formed in a central portion of an upper side of the square cross-section of the base member, and bank portions of sides of the connection groove are in close contact with an inside of corners of the member cover.

14. The battery pack of claim 1, wherein the reinforcing member assembly is elongated in a longitudinal direction of a vehicle in which the battery pack is mounted.

15. The battery pack of claim 1, wherein the reinforcing member assembly is elongated along a transverse direction of the vehicle in which the battery pack is mounted.

16. A reinforcing member assembly for a battery case of a vehicle, comprising:
a base member forming a skeleton;
a bus bar mounting groove formed by being depressed on a surface of the base member to mount a bus bar;
a connection groove formed by being depressed on the surface of the base member; and
a member cover coupled to the base member and blocking the bus bar mounting groove and the connection groove from an outside.

17. The reinforcing member assembly of claim 16, wherein the base member has a square cross-section perpendicular to a length direction of the base member,
wherein the member cover is formed in a shape surrounding sides and an upper side of the square cross-section of the base member,
wherein the bus bar mounting groove is formed on surfaces of the square cross-section of the base member,
wherein the connection groove is formed on an upper surface of the square cross-section of the base member.

18. The reinforcing member assembly of claim 17, wherein the bus bar mounting groove of the base member is disposed lower than the connection groove so as to be vertically spaced away from the connection groove.

19. The reinforcing member assembly of claim 17, wherein the connection groove is formed in a central portion of an upper side of the square cross-section of the base member, and bank portions of both sides of the connection groove are in close contact with an inside of both corners of the member cover.

20. The reinforcing member assembly of claim 17, wherein, with the bus bar mounting groove inserted into the bus bar, when a surface of the base member and a surface of the bus bar are aligned and the member cover is coupled to the base member, an inner surface of the member cover is formed to have a depth so as to be in planar contact with surfaces of the base member and the bus bar.
